(19) United States
(12) Patent Application Publication
(10) Pub. No.: US 2006/0036014 A1
(43) Pub. Date: Feb. 16, 2006

(54) Wallcovering coating

(76) Inventors: Charles R. Hogan, Williamsville, NY (US); Per-Olof Georg Algotsson, Akarp (SE); Bjorn Henrik Hjalmarson, Helsingborg (SE)

Correspondence Address: JOHNS MANVILLE;Legal Department, 10100 West Ute Avenue, Littleton, CO, 80127, US

(21) Appl. No.: 10/867,931

(22) Filed: Aug. 13, 2004

(51) Int. Cl. B32B 27/14; B32B 27/04; C08K 3/40

(52) U.S. Cl. 524/494; 442/180; 442/126; 428/196

(57) ABSTRACT

A breathable, printable, washable wallcovering prepared by applying an aqueous coating composition to a glass fiber fabric. The composition contains a modified starch such as a phosphate ester of potato starch, a polymeric latex binder, a thickener such as polyacrylic acid, and optionally, a pigment and a cross-linking agent. The wallcovering is permeable to water vapor such that moist air can pass through and not accumulate between walls and the wallcovering.

### BACKGROUND

1. Field of the Invention

The present invention relates to breathable glass fiber wallcoverings which are washable, printable and allow moisture vapor to pass therethrough.

2. Discussion of Related Art

Vinyl wallcoverings are well-known articles of commerce. Conventional vinyl wallcoverings are often relatively impermeable to water vapor and act as moisture barriers. This is a desirable characteristic for commercial and residential buildings where it is desirable to keep the wall cavity dry thus helping to prevent the growth of mold and mildew. However, the application of moisture impermeable vinyl wallcoverings in humid environments, particularly in commercial buildings such as hotels and hospitals, can cause severe problems. In a humid environment, moist air can accumulate between walls and wallcoverings. Since the vinyl wallcoverings are not breathable, moist air cannot pass through and remains trapped between the walls and the vinyl wallcoverings. This trapped moisture provides a favorable environment for the growth of mold and mildew. Such growth may lead to the production of offensive odors and discoloration of the wallcovering as well as potential medical problems for those individuals susceptible to mold and mildew.

Other characteristics desirable in wallcoverings include washability and printability. To achieve commercial acceptance, wallcoverings should allow commercial wallcovering designs similar to those applied to vinyl wallcoverings to be printed thereon. Further, the printed products should be able to withstand repeated washings. Desirably, printed wallcoverings should allow for a minimum of at least 300 scrubs per cycle, a figure which meets or exceeds the testing requirements for existing commercial vinyl wallcoverings.

U.S. Pat. No. 4,495,012 to Berenger is an example of the preparation of a glass fabric wallcovering coated with a vinyl plastisol. U.S. Pat. No. 5,545,441 also discloses vinyl resin-coated glass fabric wallcoverings. U.S. Pat. No. 4,006,273 to Wolinski et al. discloses washable wallcoverings.

Breathable wallcoverings are described in U.S. Pat. Nos. 5,876,551 and 6,238,789 to Jackson. These products are vinyl-coated substrates.

An environmentally friendly wallcovering which could be substituted for commercial vinyl wallcoverings would be highly desirable. Also highly desirable in the marketplace would be a wallcovering which combines the positive attributes of glass fiber fabrics, i.e., fire resistance, flexibility, abrasion resistance, etc., with the capability to accept printed designs which retain their appearance through repeated scrubbings.

### SUMMARY OF THE INVENTION

It is an object of the invention to provide an environmentally friendly glass fabric wallcovering which is breathable, washable and printable.

Another object of the invention is to provide a process for preparing a glass fabric wallcovering which is breathable, washable and printable.

Still another object of the invention is to provide an aqueous composition, which, when applied to glass fiber fabrics, provides a layer which is breathable, washable and printable.

These and other aspects of the invention may be attained by preparing an aqueous composition comprising a modified starch, a polymeric latex binder, a thickener, and optionally a pigment and a cross-linking agent, applying a coating of the aqueous composition to a glass fiber fabric and drying the coating to obtain a glass fabric wallcovering which is breathable, i.e., permeable to water vapor, washable and printable. According to a preferred embodiment, the modified starch is a phosphate ester of a starch, the polymeric binder is an acrylic latex, the thickener is a polymer of acrylic acid, and the cross-linking agent is a zirconium compound.

### BRIEF DESCRIPTION OF THE FIGURE OF THE DRAWING

FIG. 1 shows an arrangement of a process for producing the breathable wallcovering of the invention.

### DETAILED DESCRIPTION OF THE INVENTION

Suitable glass fiber fabrics for use in the wallcoverings of the invention include woven and non-woven materials. Preferably, the fabric is a woven product derived from glass fiber yarn. Many glass fiber yarns could be selected for use in preparing the fabric substrates. Preferred glass fabrics include woven materials prepared from C-glass or E-glass. The invention is also applicable to non-woven glass fabrics, such as those prepared by conventional wet-laid or dry-laid processes.

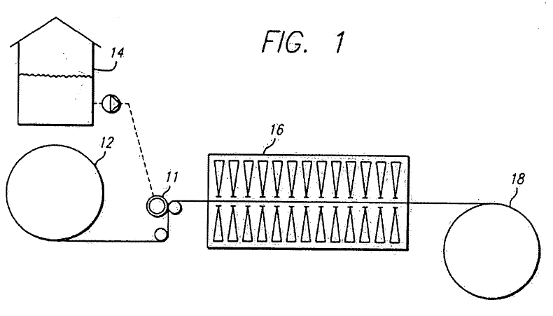

FIG. 1 shows a process for preparing a wallcovering in accordance with the present invention. A glass fabric 12 is provided in roll form. A rotary screen 11 provides a layer of an aqueous coating composition 14 to the fabric. The coated fabric is subsequently conveyed to a drying apparatus 16, preferably air-dried, and then collected in roll form 18. Instead of a rotating screen, other well-known means such as knife coating and pad coating may be employed to apply a layer of the aqueous coating formulation to the glass fabric.

The breathable coating formulation of the invention is preferably applied in the form of an aqueous dispersion having a total solids content in the range of about 5 to 25 wt. %, preferably about 10 to 20 wt. %, most preferably about 10 to 13 wt. %. The formulation includes a modified starch, a polymeric binder, a thickener, and optionally, a pigment and a cross-linking agent. The relative amounts of each ingredient can be widely varied as long as the wallcovering product has the desired moisture vapor permeability, printability and washability. Suitable dry weight ranges for the ingredients are as follows:

| Ingredient | Proportions | Preferred Proportions |
|---|---|---|
| Modified Starch | 5-25 | 15-20 |
| Polymeric Binder | 20-70 | 40-60 |
| Thickener | 0.1-10 | 0.5-5 |
| Pigment | 5-25 | 10-20 |
| Cross-Linker | 0-15 | 3-12 |

Suitable modified starches which can be employed include various commercially available anionic starches. A preferred material is a cold water-soluble phosphate ester derived from potato starch, e.g., Solvitose GF-104®. Modified starches derived from corn are also applicable.

The polymeric binders used in the formulations of the invention preferably are polymeric latices. Preferred binders include acrylic latices such as styrene/acrylic copolymers. Other suitable polymeric binders include polymers of vinyl acetate, polyacrylates and the like.

Thickeners and similar reagents used to control rheology are also present in the formulations. Polymeric thickeners are preferred and polyacrylic acids are most preferred. Polyacrylic acid thickeners are commercially available in the form of aqueous dispersions.

The aqueous formulations of the invention preferably contain a pigment. White pigments such as TiO₂ are preferred and can be added usually in the form of an aqueous dispersion. Colored pigments can also be included to create colored glass fabrics.

A cross-linking agent is preferably added to the formulation. Suitable agents include zirconium compounds, urea-formaldehyde condensates and glyoxal derivatives. Zirconium compound are preferred and ammonium zirconium carbonate is particularly preferred.

### EXAMPLE 1

The following formulation was prepared:

| | |
|---|---|
| Modified starch, a phosphate ester derived from potato | 13 kg |
| (Retabond AP, powder 5% moisture, AVEBE) | |
| Cross-linker, Ammonium zirconium carbonate | 12 kg |
| (MelCross A, 20% solids, MEL Chemicals) | |
| Co-polymer binder, styrene acrylic | 62 kg |
| (Appretan TA2250S, 50% solids, Clariant) | |
| White pigment, TiO₂ dispersion | 17 kg |
| (CWP 103, 59% solids, Exofix) | |
| Thickener, poly-acrylic acid | 6 kg |
| (Acrysol TT-615, 30% solids, Rohm and Haas) | |
| Water | 325 kg |

The mixing starts by dissolving the starch in the water. Hereafter, all other components are mixed in. The thickener goes in last. The formulation is water based with a total solids content of approximately 13-14%. The pH is 8-9 and the character is slightly anionic. The viscosity is approximately 2000-2500 cP.

The formulation is applied to a woven glass fiber fabric. The resultant product is used as a wallcovering. The product is permeable to water vapor. The coated surface is ink-receptive and can be printed with various patterns and designs. The printed surface can be repeatedly washed without fading in appearance. Thus, when subjected to the same scrubbing test as that applied to commercial vinyl wallcoverings, the wallcovering of the invention achieved a minimum of 300 scrubs per cycle.

### EXAMPLE 2

The following formulation was prepared:

| | |
|---|---|
| Modified starch, a phosphate ester derived from potato | 13 kg |
| (Solvitose GF-104, powder 5% moisture, AVEBE) | |
| Cross-linker, Ammonium zirconium carbonate | 12 kg |
| (Zirlink, 20% solids, Brenntag) | |
| Co-polymer binder, styrene acrylic | 62 kg |
| (Mowilith TA2250S, 50% solids, Celanese) | |
| White pigment, TiO₂ dispersion | 18 kg |
| (CWP 103, 59% solids, Exofix) | |
| Thickener, poly-acrylic acid | 7 kg |
| (Acrysol TT-615, 30% solids, Rohm and Haas) | |
| Water | 435 kg |

The modified starch is dissolved in the water and all other components are then mixed in with the thickener added last. The formulation has a total solids content of approximately 10-12%. The pH is 8-9 and the character is slightly anionic. The viscosity is approximately 2000-2500 cP.

### EXAMPLE 3

The following formulation was prepared:

| Components | Recipe (kg) |
|---|---|
| Retabond AP | 13.0 |
| Zirlink | 11.8 |
| Mowilith TA 2250 S | 62.0 |
| CWP 103 | 17.6 |
| Acrysol TT-615 | 7.3 |
| Release Agent | 2.6 |
| Total Water | 435 |

The components were admixed as above described. The formulation exhibited the following properties:

| | |
|---|---|
| Temperature | Max 22° C. |
| pH | 8.5-9.0 |
| Viscosity | 3000 cP |
| Solid content | 10.8% |
| Dry weight | 59.2 kg |
| Batch weight | 549 kg |

Other conventional additives can be incorporated into the coating compositions. These would include fillers, organic solvents, plasticizers, release agents, heat and light stabilizers, fungicides and the like.

All of the above-mentioned patents are herein incorporated by reference in their entirety to the same extent as if each individual reference was specifically and individually indicated to be incorporated herein by reference in its entirety.

Although the invention has been described with a preferred embodiment, it is to be understood that variations and modifications may be resorted to as will be apparent to those skilled in the art. Such variations and modifications are to be considered within the purview and scope of the clams appended hereto.

1. A breathable wallcovering comprising a glass fiber fabric coated with a composition comprising a modified starch, a polymeric binder, a thickener, and optionally, a pigment and a cross-linking agent.

2. The wallcovering of claim 1, wherein the modified starch is an anionic starch.

3. The wallcovering of claim 2, where the anionic starch is a phosphate ester of a potato-derived starch.

4. The wallcovering of claim 1, wherein the polymeric binder comprises an acrylic latex.

5. The wallcovering of claim 4, wherein the acrylic latex is a copolymer of styrene and an acrylic monomer.

6. The wallcovering of claim 1, which includes a cross-linking agent comprising a zirconium compound.

7. The wallcovering of claim 6, wherein the zirconium compound comprises ammonium zirconium carbonate.

8. The wallcovering of claim 1, wherein the thickener comprises an acrylic acid polymer.

9. The wallcovering of claim 1, wherein a pigment is present and comprises a titanium oxide.

10. The wallcovering of claim 1, wherein the glass fiber fabric is a woven material.

11. The wallcovering of claim 1, wherein the glass fiber fabric is a non-woven material.

12. The wallcovering of claim 1, which is printable.

13. The wallcovering of claim 1, further including a design or pattern printed thereon.

14. A breathable wallcovering comprising a glass fiber fabric coated with an aqueous composition comprising a phosphate-modified starch, a polymeric acrylic latex binder, a polyacrylic thickener, a pigment and a cross-linking agent.

15. The wallcovering of claim 14, wherein the aqueous composition has a solids content of about 5 to 25% by weight.

16. The wallcovering of claim 14, wherein the pigment comprises TiO₂ and the cross-linking agent comprises a zirconium compound.

17. The wallcovering of claim 14, wherein the glass fabric is a woven or non-woven material.

18. A method of preparing a breathable wallcovering which comprises applying a coating of an aqueous composition to a glass fiber fabric and drying the coating, wherein the composition comprises a modified starch, a polymeric binder, a thickener, and optionally, a pigment and a cross-linking agent.

19. The method of claim 18, wherein the glass fiber fabric is a woven or non-woven material

20. The method of claim 18, wherein the modified starch is an anionic starch.

21. The method of claim 18, wherein the aqueous composition comprises a phosphate ester of a potato-derived starch, an acrylic resin latex binder, a zirconium cross-linking compound, a polyacrylic acid thickener, and TiO₂.

22. The method of claim 21, wherein the aqueous composition has a solids content of about 5 to 25% by weight.

23. The method of claim 18, wherein the composition is applied by a rotary screen and the coating is air-dried.

24. The method of claim 18, wherein a design or pattern is applied to the coated fabric.

25. An aqueous coating composition which, upon drying, forms a breathable layer, said composition comprising a modified starch, a polymeric latex binder, a cross-linking agent, a polymeric thickener, and a pigment.

26. The coating composition of claim 25, having a solids content of about 10 to 25% by weight.

27. The coating composition of claim 25, wherein the modified starch comprises an anionic starch.

28. The coating composition of claim 27, wherein the polymeric latex binder comprises an acrylic resin.

29. The coating composition of claim 28, wherein the cross-linking agent is a zirconium compound.

30. the coating composition of claim 29, wherein the polymeric thickener is a polyacrylic acid.

31. The coating composition of claim 27, wherein the anionic starch comprises a phosphate ester of a potato starch.

32. The coating composition of claim 30, wherein the pigment comprises TiO₂.

33. A breathable, washable, printable fabric prepared by the method of claim 18.

34. A method of preparing the aqueous coating composition of claim 25, which comprises dissolving the modified starch in water, adding the polymeric latex binder, cross-linking agent and pigment to the starch-water mixture, adding the polymeric thickener and stirring the resultant admixture.
